(19) United States
(12) Patent Application Publication
(10) Pub. No.: US 2011/0305252 A1
(43) Pub. Date: Dec. 15, 2011

(54) METHOD AND APPARATUS FOR THE ADJUSTMENT OF A LASER HEAD

(75) Inventor: Matthias Niese, Neumarkt (DE)

(73) Assignee: RENA GMBH, Gutenbach (DE)

(21) Appl. No.: 13/085,788

(22) Filed: Apr. 13, 2011

(30) Foreign Application Priority Data
May 17, 2010 (DE) 102010020732.2

(51) Int. Cl. H01S 3/13

(52) U.S. Cl. 372/29.01

(57) ABSTRACT

The invention relates to a method for the adjustment of the beam axis of a laser head and an apparatus for this purpose. The method includes the steps of introducing the laser head (3) into a mounting (8), determining the set/actual deviation of the beam axis (2), determining of motions (6A and/or 6B) necessary for reduction of the deviation, and adjustment of the beam axis (2) by driving the adjusting device (4) to generate the adjusting motions (6A and/or 6B), and transmitting the adjusting motions (6A and/or 6B) via the both arms (7A, 7B) of the adjusting lever (7) to the laser head (3) which is arranged in the mounting (8).

### CROSS REFERENCE TO RELATED APPLICATIONS

This invention claims benefit of priority to German patent application serial no. DE 10 2010 020 732.2, filed on May 17, 2010; the contents of which are herein incorporated by reference in their entirety

### TECHNICAL FIELD

The invention relates to a method for the adjustment of the beam axis of a laser head and an apparatus for this purpose. In particular, the invention relates to a method and an apparatus which allow for an automated process of adjustment.

### STATE OF THE ART AND DISADVANTAGES

In the context of laser machinable materials, it is often necessary to exactly position the beam axis of the laser head in order to maintain a pre-determined position of the focal point.

Deviations which the focal point has from this set position after initial mounting of the laser head typically range in the region from ±150 μm or a radius of ±150 μm around the set position, respectively. Thus, an adjustment of the beam axis is often necessary for the compensation of unavoidable manufacturing tolerances of the laser head or of beam guiding means which are connected with the same. Also, if such a laser head must be dismounted or exchanged, e.g. for reasons of maintenance, a re-adjustment is necessary after the mounting. It is further possible that the positioning of the beam axis also changes during ongoing operation, e.g. due to setting processes or temperature variations. In this case, the production plant must be stopped until the beam axis once again has its set position after an according readjustment.

Known systems use hinged laser heads for this which are fixed by means of screws to a mounting which holds, optionally several, laser heads. However, a drawback of such supports consists in the difficulty of designing them permanently absolutely free of play without excessive efforts. Due to the use of screws it is necessary, in particular in the case of the presence of several parallel to be used laser heads, to dismount the entire mounting, even if only one single laser head must be exchanged. If all laser heads should be aligned together, e.g. in a row, this adjustment must take place on a separate adjustment platform which is arranged outside of the production plant.

### OBJECT OF THE INVENTION AND SOLUTION

Therefore, the invention has the object to allow for a simple and fast exchange of a once adjusted laser head without the need of re-adjusting the same after the mounting. Further, the invention has the object to allow for a post-adjustment of the laser head without dismounting the same during the ongoing operation of a production plant as well. Also, the invention has the object to support the laser head permanently free of play by lowest possible efforts.

### BRIEF SUMMARY OF THE INVENTION

In a first aspect of the invention a method for an adjustment of a beam axis of a laser head by using an apparatus is provided. The apparatus includes a mounting for the laser head, an adjusting device including at least one adjusting unit for adjustment of the beam axis, and an adjusting lever whose longitudinal extension is divided by a solid-body hinge into two functional arms, wherein the mounting and the adjusting device are arranged at opposing arms of the adjusting lever, and wherein the at least one adjusting unit has an adjusting axis which is different from the beam axis. The method includes the following steps: a) introducing the laser head into the mounting; b) determining a set/actual deviation of the beam axis of the laser head; c) determining motions that are necessary for reduction of the deviation; and d) aligning the beam axis by driving the adjusting device in order to generate adjusting motions, and transmitting the adjusting motions via the both arms of the adjusting lever to the laser head which is arranged in the mounting.

In another aspect of the invention, an apparatus for the adjustment of a beam axis of a laser head is provided, which includes a mounting for the laser head, an adjusting device including at least one adjusting unit for adjustment of the beam axis, and an adjusting lever whose longitudinal extension is divided by a solid-body hinge into two functional arms, wherein the mounting and the adjusting device are arranged at opposing arms of the adjusting lever, and wherein the at least one adjusting unit has an adjusting axis which is different from the beam axis.

In yet another aspect of the invention, a multi-laser block for a production plant for the generation of selective emitter paths on solar cells is provided, which includes a multitude of adjoiningly arranged apparatuses as provided, wherein each of the apparatuses can be individually aligned.

### BRIEF DESCRIPTION OF DRAWINGS

FIG. 1 shows a multi-laser block with a multitude of apparatuses according to the invention.

FIG. 2 shows as a detail of an apparatus according to the invention knurled screws that can be operated manually.

FIG. 3 shows different beam axes, which are achievable by using an apparatus according to the invention.

FIG. 4 shows the flexural-torsion hinge of an apparatus according to the invention with two interior media channels.

### DETAILED DESCRIPTION

According to the invention, a method for the adjustment of a beam axis of a laser head is carried out by using an apparatus which includes a mounting for the laser head, an adjusting device including at least one adjusting unit for adjustment of the beam axis, as well as an adjusting lever whose longitudinal extension is divided by a solid-body hinge into two functional arms, wherein the mounting and the adjusting device are arranged at the opposing arms of the adjusting lever, and wherein the at least one adjusting unit has an adjusting axis which is different from the beam axis. Such an apparatus will be described in detail later on. According to the invention, the method according to the invention comprises the following steps:

(a) introducing the laser head into the mounting;

(b) determining the set/actual deviation of the beam axis of the laser head;

(c) determining motions that are necessary for reduction of this deviation; and

(d) aligning the beam axis by driving the adjusting device in order to generate these adjusting motions and transmitting the adjusting motions via the both arms of the adjusting lever to the laser head which is arranged in the mounting.

It is clear that prior to carrying out the process steps (a) to (d) which are related to the adjustment of the beam axis, according to step (a), a laser head must be inserted into the apparatus according to the invention. It is also clear that this can be omitted in the case that the laser head is already arranged at the apparatus, for example if such an equipped apparatus is being offered in a pre-mounted, but not yet adjusted type.

The actual/set deviation to be carried out in step (b) results from the position difference between a pre-set set value and an actual value which must be determined by means of measurement.

The actual value can for example be the angle of the beam axis. Preferably, however, it is an X- or X-Y-value which indicates the position of an intersection of beam axis and treatment plane, wherein the treatment plane is defined in that in this plane, the laser beam hits the laser machinable material during operation.

The determination of the position of the beam axis can preferably take place by means of numerical methods, as long as the geometry of the according components of the apparatus and the distance between laser head is known, which normally is also the case. Also, the determination of an according compensating motion as mentioned in step (c) preferably takes place numerically. Alternatively, this determination can also take place by manual experiments.

If the set/actual deviation and the adjusting motions which are necessary for its reduction are known, according to step (d), an adjusting device is being driven for the generation of these adjusting motions. The adjusting device will be described in detail in the context of the description of the apparatus according to the invention.

Eventually, the adjusting motions are transmitted onto the laser head, the latter being arranged in a mounting by means of the lever mechanism which is formed by the two arms of the adjusting lever and which preferably is a reduction, thus achieving the adjustment of the laser heads beam axis. According to the invention, the both lever arms are formed by a solid-body hinge which defines a region of rotation. By using a solid-body hinge, a permanently backlash-free operation of the lever mechanism is ensured. The mounting for the laser head is particularly preferably designed as a quick-change mechanism. Therefore, a simple and fast exchange of the laser head is possible.

According to the invention, two preferred embodiments exist according to which the set/actual determination takes place.

According to a first embodiment, for this, the following steps are performed:

(b1) introducing laser machinable material in a treatment plane which is arranged perpendicular to the beam axis of the laser head;

(b2) driving the laser head in such a manner that a mark occurs on the laser machinable material in an intersection of beam axis and treatment plane;

(b3) determining the actual position of the mark;

(b4) determining the deviation of the actual position from a set position.

In other words, the material which is changeable by means of the laser beam is brought into a production plant in which the apparatus according to the invention is installed. A mark is generated by means of a “test treatment” which corresponds to the focal point of the laser head during operation. It is possible to determine which adjusting motions are necessary in order to bring the effectively achieved actual value in correlation with the desired set value by means of manual or automatic recording of the position of the mark and subsequent comparison with a set value.

According to another, preferred embodiment, the following steps are performed for the set/actual determination:

(b1) introducing an optical measurement device in a treatment plane which is arranged perpendicular to the beam axis of the laser head;

(b2) driving the laser head in such a manner that, in an intersection of beam axis and treatment plane, a signal of the actual position of the intersection occurs in the optical measurement device;

(b3) determining the deviation of the actual position from a set position.

So, according to this embodiment, no mark is generated, but the measurement is performed by irradiating an according optical measurement device without the detour via a laser machinable material. It is therefore optionally necessary to reduce the power of the laser, to introduce a filter into the beam path, or to use a low power pilot beam in order not to damage the optical measurement device. Then, the measurement signal directly correlates with the actual position of the focal point as long as the optical measurement device lies with its measurement area in the treatment plane. A particular advantage of this embodiment is that electrical signals are immediately present. Thus, a control circuit can be built in a simple manner which comprises the optical measurement device, an optional control unit, and the adjusting device.

It is further particularly preferred, that in a subsequent step it is determined if the deviation between the actual position and the set position is smaller than a preset limit, and that all steps are subsequently carried out as often until the limit is reached or under-run. After each iteration it is checked whether the remaining deviation under-runs a preset limit, and the repeating loop is only exited when the limit is under-run. It is clear that the aforementioned step (a) of introducing the laser head into the mounting must only take place once, i.e. before performing the remaining steps.

In the preferred case of using an optical measurement device, this iterative adjustment virtually takes place in real time since it is possible to continuously measure, calculate, and adjust.

As already mentioned, it is particularly preferred that the determination of the motion(s) that is/are necessary for reduction of the deviation, and/or driving of the adjusting device, as well as the optional determination of the set/actual deviation takes place automatically. This automation is possible according to the embodiment wherein laser machinable material is marked, as well as according to the embodiment with a directly irradiated optical measurement device. However, also in the first case, an optical measurement device must be provided for this. However, the latter is not directly irradiated, but records the position of the aforementioned intersection in a time-shifted manner, i.e. after the laser machinable material has left the range of action of the laser. Particularly suitable for this are measurement cameras, for example line-scan cameras, in combination with digital image processing.

Two alternatives can be provided for adjustment of the beam axis of a laser head.

According to one embodiment, the adjustment of the beam axis takes place prior to the mounting of the laser head into a production plant. This is of particular advantage if a multitude of adjusted laser heads must be kept ready in order to keep the downtime of a production plant as short as possible, and if the adjustment of a laser head takes place at least partially manually.

According to another embodiment, the adjustment of the beam axis takes place after the mounting of the laser head into a production plant. In particular for the case of an automatic adjusting, almost no disadvantages in terms of time are to be expected.

Further, it can be necessary to re-adjust the beam axis after performing the initial adjustment. Therefore, according to a further embodiment, adjustment of the beam axis takes place during the operation in a production plant. This means that the positioning of the aforementioned intersection or focal point, respectively, is intermittently or continuously monitored and, if necessary, immediately corrected.

It is particularly preferred that the adjustment of the beam axis takes place during the ongoing transport of laser machinable material, and that the mark is line shaped. In this case as well, an optical measurement device which can be directly irradiated can be used, which, however, can only deliver a signal when a gap of two subsequent material sections occurs. If the position of the focal point shall be continuously monitored, or if e.g. continuous material is present in the production plant, the aforementioned optical measurement device is particularly suitable in this case for the time-shifted determination of the actual position.

The invention further discloses an apparatus for the adjustment of the beam axis of a laser head. According to the invention, this apparatus comprises a mounting for the laser head, an adjusting device comprising at least one adjusting unit for adjustment of the beam axis, as well as an adjusting lever. In the following, these components of the apparatus are described more precisely.

The mounting for the laser head serves for the fixation of the same to the apparatus according to the invention. In contrast, the laser head itself is not a component of the apparatus, but, however, functionally assigned to the same.

According to the invention, the apparatus according to the invention comprises at least one adjusting unit for adjustment of the beam axis. Adjusting motions are generated in direction of at least one adjusting axis by means of the adjusting device.

According to the invention, the at least one adjusting axis is different from the beam axis. This means that none of these axes runs co-linear to another.

It further comprises an adjusting lever at the one end of which the adjusting device, and at the other end of which the mounting for the laser head is arranged. The longitudinal extension of the adjusting lever is divided by a solid-body hinge into two functional arms. The solid-body hinge defines a region of rotation. Accordingly, the mounting and the adjusting device are arranged at the opposing arms of the adjusting lever. When the beam axis runs approximately vertical, then, by definition, the one end is located in the upper the region of the adjusting lever, and the other end is located in the lower region of the same. However, as a matter of course, an operation with an, for example, horizontally running beam axis is possible as well, so that the both ends are e.g. arranged at the left and the right hand side. Further, an adjusting lever is also possible which does not exhibit a longitudinal extension. It is only essential that it can be divided into two lever arms which are defined by the position of the solid-body hinge or its region of rotation, respectively.

Since the adjusting lever according to the definition must exhibit a leverage, the same requires a pivot. According to the invention, a solid-body hinge is used for this which is located at the transition from the first to the second arm of the adjusting lever, as already mentioned before. By using a solid-body hinge instead of, for example, a knuckle, a permanently absolutely backlash-free hinge is provided. Furthermore, such a hinge is simple to manufacture, since it does not comprise any moving parts. A further advantage results from that the pre-tension of the adjusting lever allows, in connection with the solid-body hinge, to omit from counter-springs which act against an adjusting motion in order to keep the same free of play. According to the concrete design of the solid-body hinge, the actual joint function concentrates on a precisely defined point (pivot), or it distributes over a larger region of the solid body joint (region of rotation). Regardless, however, the application of an adjusting motion onto one end of the adjusting lever always results in a change of position of the mounting for the laser head which is arranged at the other end. Herein, the precise position of the pivot or the region of rotation is of minor importance, as long as it is reproducible. The shape of the solid body hinge can be elongated, bent, or spiral-shaped. Its cross section can for example be round or rectangular, and it can be shaped differently along the longitudinal extension.

According to a preferred embodiment, the adjusting axis as well as the beam axis is/are arranged perpendicular to each other. This means that the optionally three axes match with the three spatial directions of a right angled coordinate system. If additionally, the condition is met that one of the both adjusting motions points into or against a linear transport direction of the objects to be treated, a particularly simple determination of the adjusting motions which are necessary for reduction of a known set/actual deviation results from this.

Depending on adjusting motions, the solid-body hinge is bent and/or twisted. Therefore, it is also possible to speak of a flexural-torsion hinge. The solid-body hinge is therefore, according to a preferred embodiment, formed by a flexural-torsion hinge which is firmly fixed to the adjusting lever with its one end, and which is fixable to an abutment with its other end. The solid-body hinge can be screwed, welded, or glued to the adjusting lever, and it can consist of the same or of another material as the adjusting lever. Furthermore, it can be formed integrally with the adjusting lever.

Since the solid-body hinge which is preferred according to the invention has a linear or bent rod shape, the end which is not connected with the adjustment lever must serve as abutment, so that the hinge function which is necessary according to the invention can be provided. For this, this end is connected with a part of the production plant in such a manner that it is immovably fixed. On the contrary, the other end can swing freely together with the adjusting lever in certain boundaries.

In a particularly preferred embodiment, the mounting for the laser head is designed as a quick-change fastener. For this, various constructions are possible. Particularly preferred, such a quick-change fastener comprises a protrusion which extends at the lower end of the adjusting lever in direction of the laser head and which provides a defined positioning edge, as well as a locking mechanism which is movable in longitudinal direction of the adjusting lever and which can be fixed to the same. The exact mode of action is given in the context of the figure description to which reference is made.

In certain cases it can be necessary to deliver liquid and/or gaseous media such as e.g. phosphoric acid or helium to the laser head. Therefore, according to a particularly preferred embodiment, the solid-body or flexural-torsion hinge has at least one media channel. This media channel has suitable fluidic interfaces which allow for a lossless transition of the media into the media channel as well as out of the same. An essential advantage of this construction consists in that when exchanging the laser head, no additional steps for coupling according media supplies are necessary. A faster and more secure procedure in case of an exchange results from that.

In order to ensure the adjustability of the adjusting unit(s), the at least one adjusting unit comprises a knurled screw and/or a motorized drive, wherein the latter is preferred, since this enables an automation of the adjustment process.

According to a further embodiment, the adjusting device comprises only one adjusting unit with an eccentric motor. The same is arranged in such a manner at one end of the adjusting lever and interacts with the same such that, by means of a tumbling motion, adjusting motions into or against a transport direction as well as diagonally to the same, and into combinations of these directions are possible.

According to a further embodiment, the region of rotation is arranged in such a manner that a leverage of 10:1 is achievable between adjusting device and an intersection of beam axis of the laser head with a treatment plane. From this results a reduction of the adjusting motion to the motion of the laser head, It must be obeyed that the leverage does not relate to the ratio of the lengths of both arms of the adjusting lever, but that the length of the second (lower) arm is substituted by the distance of the region of rotation from the actual treatment plane. Depending on the desired precision of adjustment, the leverage can be smaller or greater that 10:1 as well.

In order to enable an automation and improved precision of the adjustment process, according to a particularly preferred embodiment, the apparatus according to the invention further comprises an optical measurement device for determination of the adjustment of the laser head, and/or a control unit for driving and optionally controlling the adjusting device. As already mentioned above, this optical measurement device can be suitable for direct irradiation by the laser beam, or for time-shifted recording of the mark(s) resulting from the beam. A combination of both variants in one apparatus is possible as well. In this way, a control circuit can be built by interaction with a control unit for the adjusting device, which allows a largely automatic adjustment of the beam axis of the laser head.

The invention further discloses a multi-laser block for a production plant for the generation of selective emitter paths on solar cells. Such a multi-laser block serves for the centralization of several laser heads and their adjustment devices into an easy-to-handle unit. Accordingly, a multi-laser block according to the invention comprises a multitude of adjoiningly arranged apparatuses as defined above, wherein each of these apparatuses can be individually adjusted. In this way, each of the laser heads can be adjusted without dismounting it from the production plant and without a longer downtime of the same.

The method and the apparatus according to the invention offer a number of advantages over the prior art. A permanently absolutely backlash-free hinge is provided by using a solid-body hinge instead of a common knuckle. Its inherent pre-tension allows to omit counter-springs in the region of the adjustment units. By using a quick-change fastener, a fast exchange of a single laser head is possible. By provision of an according positioning edge at the adjusting lever as well as according, geometric features of the laser head interacting with the fastener, the re-adjusting of the laser head after the mounting becomes unnecessary. By means of the preferably automated adjustment and in connection with an optical measurement device it is possible to achieve, even during continuous operation, a post-adjustment of the beam axis of the laser head.

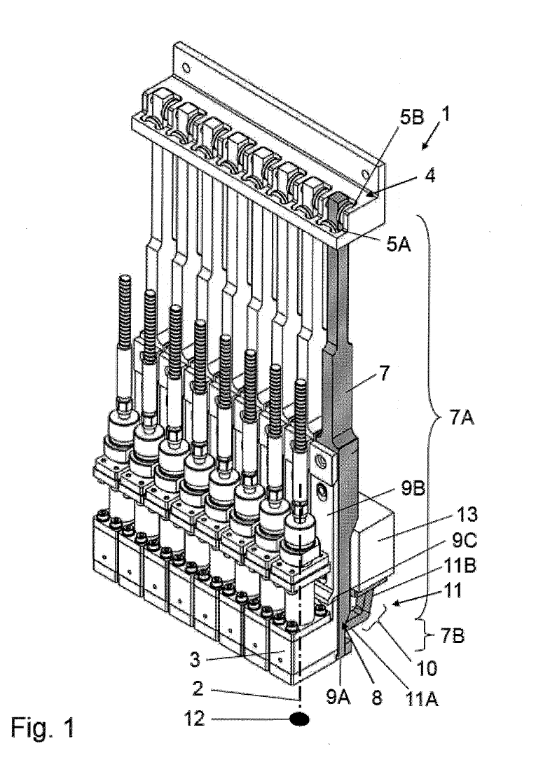

Turning now to the Drawings, an individual apparatus of the assembly as shown in FIG. 1 is depicted slightly darker for the sake of better visualization.

In the upper region of apparatus 1, the adjusting device 4 is located. The same comprises two adjusting units 5A, 5B, which are designed as knurled screws. The knurled screws are located at the upper end of an adjusting lever 7. A laser head 3 is arranged at the lower end of the adjusting lever 7. The same is detachably fixed to the adjusting lever 7 by means of a mounting 8 which is designed as a quick-change fastener. The quick-change fastener consists essentially of a protrusion 9A which extends at the lower end of the adjusting lever 7 in direction of the laser head 3 and which provides a defined positioning edge, as well as of a locking mechanism 9B which is movable in longitudinal direction of the adjusting lever 7 and which can be fixed to the same. Firstly, the laser head 3 is engaged with the protrusion 9A for mounting of the laser head 3 into the multi-laser block. Then, the laser head 3 is adjusted in such a manner that its back wall bears flat against the adjustment lever 7. Subsequently, the locking mechanism 9B is moved along the longitudinal direction of the adjusting lever 7 as long in direction of the laser head 3 until the laser head 3 is clamped by the locking mechanism 9B and thus fixed to the adjusting lever 7. For this, the locking mechanism 9B comprises a clamping protrusion 9C which interacts with an upper edge of the laser head 3. Finally, the locking mechanism 9B itself is fixed by means of a screw to the adjusting lever 7. In this manner, a simple and fast exchange of a single laser head 3 is possible without having to re-adjust its beam axis 2 (dash-dotted line).

A solid-body hinge 11 is arranged at the adjusting lever 7A in close proximity to the latter's lower end, which fulfills the function of a swivel joint. The same defines or comprises a region of rotation 10. The solid-body hinge 11 is, according to the depicted preferred embodiment, formed by a flexural-torsion hinge, or it is comprised by the same. The flexural-torsion hinge 11 is firmly fixed to the adjusting lever 7 with its one end 11A, and it is fixable to an abutment with its other end 11B. In the depicted embodiment, the other end 11B is fixed to a supply block 13, which in turn is firmly attached to the surrounding production plant (not shown), thus forming an abutment for the flexural-torsion hinge 11 and the adjusting lever 7 which is connected with it.

A plane which runs through the region of rotation 10 and which stands perpendicular to the longitudinal axis of the adjusting lever 7 divides the adjustment lever 7 into two arms, namely a first arm 7A and a second arm 7B. The leverage between these two arms 7A, 7B is dimensioned such that a leverage of 10:1 is provided between adjusting device 4 and the focus which corresponds to an intersection 12 of the beam axis 2 of the laser head 3 with a treatment plane (not shown). It is not necessary that the region of rotation 10 is precisely arranged on the longitudinal axis of the adjusting lever 7 or the beam axis 2 of the laser head 3; it can, as shown, also be positioned outside of these axes. Since the laser head 3 is fixed to the lower part of the adjusting lever 7, position variations of the second arm 7B also have an immediate effect on the position of the laser head 3 and therefore, to its beam axis 2. Therefore, a motion of the adjusting units 5A, 5B which are arranged at ₜhe one end of the adjusting lever 7 results in a displacement of the focus 12 with the ratio 10:1, so that a fine adjustment of the position of the second arm 7B and therefore of the focus 12 is possible. The pre-tension which is necessary for the adjustment is generated by the material of the adjusting lever 7 itself, which is bent during adjustment in a controlled manner. Thanks to this pre-tension the knurled screws do not need any counter nuts, counter springs, or the like.

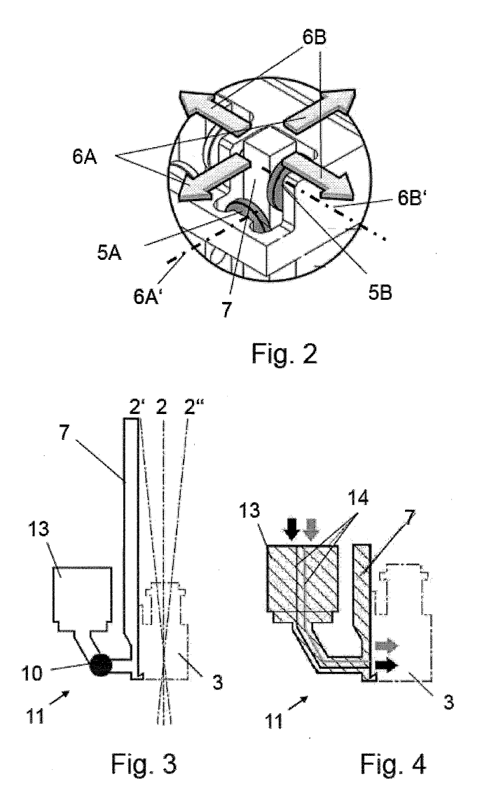

FIG. 2 shows a detail of the apparatus according to the invention 1. The view direction corresponds to the one from FIG. 1. The adjusting lever 7 whose one, upper end is visible, is bent in direction of the adjusting motion 6A by turning the adjusting unit 5A. The adjusting force acts along the adjusting axis 6A′. In the case that the transport of a substrate (not shown) takes place in direction of the adjusting axis 6A′, the beam axis of the laser head (both not shown) can be changed into or against this transport direction.

However, the adjusting lever 7 is bent in direction of the adjusting motion 6B and thus, diagonally to the direction of the adjusting motion 6A, by turning the adjusting unit 5B. The adjusting force acts in direction of the adjusting axis 6B′ . As a result, the beam axis of the laser head (both not shown) is changed perpendicular to said transport direction. In this manner, the track of an individual laser head, but also the lateral distance of several laser heads to each other, can be adjusted. Furthermore, in the depicted embodiment, the adjusting axes 6A′, 6B′ as well as the beam axis stand perpendicular to each other. Therefore, a particularly simple pre-calculation of adjusting motions is possible, for example in the context of an automatic control, which is based on a set/actual comparison between a desired and the actual position of a focal point on a laser machinable material. In a non-depicted alternative, the knurled screws are substituted by motor drives.

In FIG. 3, the possibility is depicted to adjust different beam axes, which are achievable by using an apparatus according to the invention. Shown is the adjusting lever 7, the solid-body hinge 11 which is designed as a flexural-torsion hinge with the region of rotation 10 being depicted as filled circle, a supply block 13 serving as an abutment, the dash-dotted contour of the laser head 3, as well as three beam axes 2, 2′, 2′', also drawn in dash-dotted lines. By operating the adjusting device (not shown), the beam axis 2 which is shown as a vertical can be transformed into an accordingly deflected beam axis 2′ or 2″, respectively. In fact, the region of rotation 10 of the solid-body hinge 11 is neither located in the intersection of the three beam axes 2, 2′, 2″, nor in the interior of the laser head 3; as depicted, this is, however, unproblematic, since the deflected beam axes 2′, 2″ can be reached also by tilting the laser head 3 around the region of rotation 10 shown in FIG. 3.

FIG. 4 shows as a detail a cut view of a particularly preferred embodiment of the flexural-torsion hinge 11 of an apparatus according to the invention. The same comprises several (here: two) media channels 14 running inside of it. The media channels further run through the supply block 13 and subsequently through the solid-body hinge 11. They end at the bearing surface of the adjusting lever 7, which is provided for the laser head 3 which is shown as a dash-dotted contour. The media which are transported within the media channels are then taken up by the latter. There, they serve for example for the beam forming and/or for the treatment support (respectively not shown).

### List of references

1 apparatus
2 beam axis
3 laser head
4 adjusting device
5A, 5B adjusting unit
6A, 6B adjusting motion
6A′, 6B′ adjusting axis
7 adjusting lever
7A first arm
7B second arm
8 mounting
9A protrusion
9B locking mechanism
9C clamping protrusion
10 pivot
11 solid-body hinge, flexural-torsion hinge
11A one end of the flexural-torsion hinge
11B other end of the flexural-torsion hinge
12 intersection, focus
13 supply block
14 media channel

What is claimed is:

1. A method for an adjustment of a beam axis (2) of a laser head (3) by using an apparatus (1) which comprises a mounting (8) for the laser head (3), an adjusting device (4) comprising at least one adjusting unit (5A, 5B) for adjustment of the beam axis (2), and an adjusting lever (7) whose longitudinal extension is divided by a solid-body hinge (11) into two functional arms (7A, 7B), wherein the mounting (8) and the adjusting device (4) are arranged at opposing arms (7A, 7B) of the adjusting lever (7), and wherein the at least one adjusting unit (5A, 5B) has an adjusting axis (6A′, 6B′) which is different from the beam axis (2), wherein the method comprises the following steps:
(a) introducing the laser head (3) into the mounting (8);
(b) determining a set/actual deviation of the beam axis (2) of the laser head (3);
(c) determining motions (6A and/or 6B) that are necessary for reduction of the deviation; and
(d) aligning the beam axis (2) by driving the adjusting device (4) in order to generate adjusting motions (6A and/or 68), and transmitting the adjusting motions (6A and/or 6B) via the both arms (7A, 7B) of the adjusting lever (7) to the laser head (3) which is arranged in the mounting (8).

2. The method according to claim 1, wherein the set/actual determination takes place be means of the following steps:
(b1) introducing laser machinable material in a treatment plane which is arranged perpendicular to the beam axis (2) of the laser head (3);
(b2) driving the laser head (3) in such a manner that a mark occurs on the laser machinable material at an intersection (12) of beam axis (2) and treatment plane;
(b3) determining an actual position of the mark; and
(b4) determining a deviation of the actual position from a set position.

3. The method according to claim 1, wherein the set/actual determination takes place be means of the following steps:
(b1) introducing an optical measurement device in a treatment plane which is arranged perpendicular to the beam axis (2) of the laser head (3);
(b2) driving the laser head (3) in such a manner that, at an intersection (12) of beam axis (2) and treatment plane, a signal of an actual position of the intersection occurs in the optical measurement device; and
(b3) determining a deviation of the actual position from a set position.

4. The method according to claim 1, wherein a subsequent step comprises determining if the deviation between the actual position and the set position is smaller than a preset limit, and wherein all steps are subsequently carried out until the limit is reached or under-run.

5. The method according to claim 1, wherein the steps of determing motion(s) that is/are necessary for reduction of the deviation, and/or driving of the adjusting device (4), and optionally determining the set/actual deviation takes place automatically.

6. The method according to claim 1, wherein the adjustment of the beam axis (2) takes place prior to and/or after the mounting of the laser head (3) into a production plant and/or during the operation of a production plant.

7. The method according to claim 6, wherein the adjustment of the beam axis (2) takes place during ongoing transport of laser machinable material, and wherein the mark is line shaped.

8. An apparatus (1) for the adjustment of a beam axis (2) of a laser head (3), comprising a mounting (8) for the laser head (3), an adjusting device (4) comprising at least one adjusting unit (5A, 5B) for adjustment of the beam axis (2), and an adjusting lever (7) whose longitudinal extension is divided by a solid-body hinge (11) into two functional arms (7A, 7B), wherein the mounting (8) and the adjusting device (4) are arranged at opposing arms (7A, 7B) of the adjusting lever (7), and wherein the at least one adjusting unit (5A, 5B) has an adjusting axis (6A′, 6B′) which is different from the beam axis (2).

9. The apparatus according to claim 8, wherein the adjusting axis (6A′, 6B′) and the beam axis (2) is/are arranged perpendicular to each other.

10. The apparatus according to claim 8, wherein the solid-body hinge (11) is formed by a flexural-torsion hinge which is firmly fixed to the adjusting lever (7) with its one end (11A), and which is fixable to an abutment with its other end (11B).

11. The apparatus according to claim 10, wherein the flexural-torsion hinge (11) has at least one media channel (14).

12. The apparatus according to claim 8, wherein the at least one adjusting unit (5A, 5B) comprises a knurled screw and/or a motorized drive.

13. The apparatus according to claim 12, wherein the adjusting device (4) comprises only one adjusting unit (5A) with an eccentric motor.

14. The apparatus according to claim 8, wherein the pivot region (10) is arranged in such a manner that a lever ratio of 10:1 is achievable between the adjusting device (4) and an intersection (12) of the beam axis (2) of the laser head (3) with a treatment plane.

15. The apparatus according to claim 8, further comprising an optical measurement device for determining an orientation of the laser head (3), and/or further comprising a control unit for driving and optionally controlling the adjusting device (4).

16. A multi-laser block for a production plant for the generation of selective emitter paths on solar cells, comprising a multitude of adjoiningly arranged apparatuses (1) as defined in claim 8, wherein each of the apparatuses (1) can be individually aligned.
